(19) United States
(12) Patent Application Publication
(10) Pub. No.: US 2003/0029800 A1
(43) Pub. Date: Feb. 13, 2003

(54) ULTRAPURIFICATION METHOD AND SAMPLER

(76) Inventors: ELISHA TEL-OR, REHOVOT (IL); NAVA COHEN, BAT HEFER (IL); HOVAY ZAFRIR, REHOVOT (IL); DANIELLE ILZYCER, NESS ZIONA (IL); IRITH GILATH, REHOVOT (IL); ABRAHAM MEY-MAROM, BAT-YAM (IL)

Correspondence Address: BROWDY AND NEIMARK, P.L.L.C.., 624 NINTH STREET, N.W., SUITE 300, WASHINGTON, DC, 20001, US

(21) Appl. No.: 09/194,545

(22) PCT Filed: May 29, 1997
(86) PCT No.: PCT/IL97/00172

(30) Foreign Application Priority Data
May 30, 1996 (IL) 118467
Apr. 11, 1997 (IL) 120652

(51) Int. Cl. C02F 1/42

(52) U.S. Cl. 210/688

(57) ABSTRACT

The remarkable metal binding properties of the dried biomass of the water fern Azolla are exploited to purify various contaminated liquids. One aspect of the invention relates to a method for the ultrapurification of an aqueous solution from a heavy metal ion comprising passing the solution through a dried biomass of the water fern Azolla. Further aspects relate to the reclamation of potable water from contaminated water and the purification of radioactivity contaminated liquid waste. Also disclosed is a sampler for determining the presence of a heavy metal ion in an aqueous solution comprising a receptacle containing a dried biomass of the water fern Azolla.

### FIELD OF THE INVENTION

The present invention relates to the use of the metal ion binding property of the water fern Azolla in a method for ultrapurification and in a metal ion sampler.

### BACKGROUND OF THE INVENTION

The removal of metal ion contaminants from aqueous media or waste waters released by various chemical, coating, and nuclear industries, etc., is one of the major problems in environmental protection. Various effluents have to be cleaned up before they can be discarded into open water reservoirs, or released to rivers, sewage or the like. Environmental protection regulations of developed and industrial states generally restrict the content of metal ions in water to the ppb range (μg/Kg). The analysis of liquids containing such low concentration of metal ion contaminants is often limited by the sensitivity and resolution of conventional analytical methods (such as XRF, AAS, ICP and ICP-MS).

U.S. Pat. No. 5,000,852 to Tel-Or, incorporated by reference, discloses means and processes for the reduction of the concentration of transition metals in various aqueous media. The Tel-Or patent utilizes the metal ion-binding capability of the water fern Azolla to remove metal ions from aqueous solutions. The Azolla was used both in its living state by growing the fern in the contaminated media, as well as in a lifeless state in the form of a column of dried biomass.

Experiments are described in the Tel-Or patent in which solutions containing hundreds of ppm (mg/Kg) of a metal ion were reduced to a few ppm by passing the solution through an Azolla biomass column. However, this level of purification is insufficient to meet the stringent environmental standards presently in force in most developed countries. Examples of these standards are given in Table I below:

TABLE I
Examples of limit values of metal concentrations
in water (under environmental protection
regulations):

| | Israel | Germany | Switzerland |
|---|---|---|---|
| | Concentration | Concentration | Concentration |
| Metals | in ppb | in ppb | in ppb |
| Hg, (Mercury) | 5 | 50 | 10 |
| Mo, (Molybdenum) | 50 | | |
| Cr3+, (Chromium) | 250 | 1000 | 2000 |
| Cr6+, (Chromium) | 100 | 200 | 500 |
| Pb, (Lead) | 250 | 1000 | 500 |
| Cd, (Cadmium) | 50 | 200 | 100 |
| Ni, (Nickel) | 500 | 1000 | 2000 |
| Co, (Cobalt) | 250 | 1000 | 500 |
| Cu, (Copper) | 500 | 1000 | 1000 |
| Ag, (Silver) | 50 | 2000 | 100 |
| Li, (Lithium) | 300 | | |

Furthermore, the initial concentration of the solutions to be purified was in the range of 100-17,000 ppm, while many contaminated liquids contain initial concentrations of <100 ppm. Although other experiments were described in which the initial concentration of metal ion was 20-30 ppm, these experiments involved the living Azolla, which binds metal ions by a mechanism different from that of the dried biomass.

The Tel-Or patent does not describe any device which can be used for concentrating metal ions.

### BRIEF SUMMARY OF THE INVENTION

It is an object of the present invention to provide a method for the ultrapurification of aqueous solutions from heavy metal ions to a degree which at least meets environmental regulation requirements.

It is a further object of the present invention to provide a device which can qualitatively and/or quantitatively determine the presence of heavy metal ions in an aqueous solution, even when these ions are at a very low concentration and/or are mixed with other types of ions or contaminants.

According to one aspect of the present invention, there is provided a method for the ultrapurification of an aqueous solution from a heavy metal ion comprising passing said solution through a dried biomass of the water fern Azolla.

In a preferred embodiment of the present invention, the biomass is contained in a column.

According to another aspect of the present invention there is provided a sampler for determining the presence of a heavy metal ion in an aqueous solution comprising a receptacle containing a dried biomass of the water fern Azolla, wherein said biomass binds said metal ion.

In the present specification, “ultrapurification” refers to the purification of a contaminated solution to a level of contaminant which is much less than 1 ppm, and generally in the range of ppb, ppt, or lower i.e. an ultrapure solution.

The present invention is based on the surprising discovery that a lifeless Azolla biomass is capable of binding not only transition metals, as described in the Tel-Or patent, but also all heavy metal ions including Cs, Sr, Ce and Zr. Furthermore, Azolla biomass has been found capable of binding metal ions in aqueous solutions in a concentration range of up to nine orders of magnitude, from hundreds of ppm's to much less than one ppt (ng/Kg), limited only by the saturation of the amount of biomass used. This results in the ultrapurification of the contaminated solution to within a concentration range allowed by environmental authorities.

In living water fern Azolla, the metal absorption and uptake processes are diffusion and metabolic processes, respectively. The absorption process for all the metals first takes place in the fern roots. Most of the metals accumulate in the roots while some of the metals are translocated to the shoot and the leaves. The metal translocation to the shoot and leaves is limited by the defense system of the plant.

In dry biomass Azolla, on the other hand, the metal accumulation and binding is a pure chemical, mainly ion exchange process. The metal accumulation is at least 7 fold greater than for the living Azolla. The metal accumulation in living Azolla is a slow process, lasting for hours and days, while for dry Azolla the accumulation process takes place practically instantly.

Thus, the Azolla biomass has been found to be superior in at least five aspects: (1) the range of ions which can be bound; (2) the specificity of ion-binding; (3) the ability to bind ions at very low concentrations; (4) the ability to produce ultrapure solutions; and (5) the ability to concentrate heavy metal ions up to three orders of magnitude.

Due to the superior properties of the Azolla biomass, it has been possible to prepare a sampler which specifically binds and concentrates heavy metal ions from a contaminated aqueous solution. This allows the determination and quantitation of a heavy metal ion in a body of water even at very low concentrations which are below the measuring range of conventional measuring methods. Furthermore, the specificity of binding of the Azolla biomass allows binding of heavy metal ions even in the presence of high concentrations of other ions and contaminants which generally saturate conventional binding resins.

### BRIEF DESCRIPTION OF THE DRAWINGS

FIG. 1 illustrates one embodiment of a bag sampler.

FIG. 2 illustrates one embodiment of a column sampler.

FIG. 3 illustrates one embodiment of a funnel sampler.

FIG. 4 illustrates one embodiment of a flat sampler.

FIG. 5 illustrates one embodiment of a chain of flat samplers.

### DETAILED DESCRIPTION OF PREFERRED EMBODIMENTS

### I. Methods

a) Based on ICP Analysis

A 15 cm length and 1 cm diameter column is filled with 2 g of crumbled and rehydrated Azolla. A water solution containing the metal ion at a known concentration is pumped through the column at an optimal selected and constant flow rate. Volume fractions of the column effluent are collected in vials at specific time intervals during the entire procedure. The concentration of the metal ion in the initial solution and in the effluent volume fractions are analyzed by induced coupled plasma (ICP). The metal ion concentration of the final solution is determined from the ICP results of the effluent volume fractions analysis. The percentage of metal ion removal is calculated from the initial and final metal ion concentrations.

b) Based on Radiological Analysis

A 15 cm length and 1.5 cm diameter column is filled with 5 g of crumbled and rehydrated Azolla. A water solution containing a known concentration of the metal ion, which has been irradiated by neutrons inside a nuclear reactor core and serves as a radioactive emitter isotope, is pumped through the column at a pre-selected and constant flow rate. The column effluent is collected in a jar. The radioactivity of the metal ion isotope, in the initial solution, in the final solution and in the Azolla column, is measured by γ-spectrometry. The concentration of the metal ion in the initial solution, the final solution and the Azolla column is calculated from the radiological measurements. The percentage of ion metal removal is calculated from the initial and final ion metal concentrations.

### II. Azolla material

The Azolla water fern includes a variety of species including Azolla filiculoids, Azolla pinnata, Azolla imbricata, Azolla africana, Azolla caroliniana, Azolla mexicana, Azolla nilotica, Azolla microphyla, Azolla rubra and Azolla japonica. Azolla dried biomass generally consists of dry or rehydrated dried Azolla, dry or rehydrated crumbled dried Azolla, or dry or rehydrated powdered dried Azolla. Thus, Azolla biomass does not contain living material.

### III. Results

Azolla biomass has been found to take up heavy metals ions such as Cu, Zn, Ni, Cr, Pb, Cd, U, Cs, Ce, Ru, Sr, Zr, Ag and Au over a broad range of pH values, from pH=2 up to pH=11. Solutions of the above metal ions can be passed through columns of Azolla biomass or mixed with Azolla biomass. Preferably, Azolla biomass is inserted in columns of miscellaneous sizes (diameters and lengths). Small sized columns can be used for small and medium volume solutions, while larger sized columns can be used for large volume solutions.

As much as 99.9% of the initial metal concentration can be removed from the solution, reducing the metal ion content in the contaminated solution by up to 3 orders of magnitude. A number of examples follow:

TABLE II
Uptake of some heavy metal ions by column
of crumbled rehydrated Azolla dried
biomass in a single pass
(small vol. of solution)

| | | | Bio- | | | | | % |
|---|---|---|---|---|---|---|---|---|
| Heavy | Volume | | mass | Initial | | Final | | Re- |
| Metal | of Sol. | | amount | solution | | solution | | mov- |
| Ion | (ml.) | pH | (grams) | conc. | | conc. | | al |
| Strontium | 1200 | 7 | 2 | 1 | ppm | 8 | ppb | 99.2 |
| | 1200 | 7 | 2 | 5 | ppm | 10 | ppb | 99.8 |
| | 1000 | 7 | 2 | 10 | ppm | 14 | ppb | 99.9 |
| | 500 | 10 | 2 | 47 | ppm | 50 | ppb | 99.9 |
| Zirconium | 1000 | 2 | 5 | 5 | ppm | 400 | ppb | 92 |
| Uranium | 600 | 4.5 | 2 | 5 | ppm | 61 | ppb | 98.8 |
| | 500 | 2.4 | 2 | 10 | ppm | 200 | ppb | 98.0 |
| Lead | 1400 | 7 | 2 | 100 | ppm | 30 | ppm | 99.97 |
| Cesium | 1250 | 7 | 5 | 1 | ppb | 20 | ppt | 98 |
| | 1175 | 10.5 | 5 | 100 | ppb | 200 | ppt | 99.8 |
| | 1080 | 10.5 | 5 | 5 | ppm | 7.5 | ppb | 99.8 |

Column size for 2 gram Azolla biomass: 1 cm diameter and 15 cm length
Column size for 5 gram Azolla biomass: 1.5 cm diameter and 15 cm length

TABLE III
Uptake of some heavy metal ions by column
of crumbled rehydrated Azolla dried
biomass in a single pass
(large vol. of solution)

| | | | Bio- | | | | | % |
|---|---|---|---|---|---|---|---|---|
| Heavy | Volume | | mass | Initial | | Final | | Re- |
| Metal | of Sol. | | amount | solution | | solution | | mov- |
| Ion | (Liters) | pH | (Kg.) | conc. | | conc. | | al |
| Lead | 1000 | 7 | 2.4 | 120 | ppb | 10 | ppb | 91.7 |
| | 1000 | 7 | 2.4 | 1 | ppm | 14 | ppb | 98.6 |
| | 1000 | 7 | 2.4 | 3.5 | ppm | 7 | ppb | 99.8 |

Column size: 20 cm diameter and 60 cm length

TABLE IV
Uptake of some heavy metal ions by column
of rehydrated Azolla dried biomass
in a single pass (large
volume of solution)

| | | | Bio- | | | | | % |
|---|---|---|---|---|---|---|---|---|
| Heavy | Volume | | mass | Initial | | Final | | Re- |
| Metal | of Sol. | | amount | solution | | solution | | mov- |
| Ion | (Liters) | pH | (Kg.) | conc. | | conc. | | al |
| Lead | 1000 | 7 | 2.4 | 500 | ppb | 10 | ppb | 98 |
| | 1000 | 7 | 2.4 | 1 | ppm | 11 | ppb | 98.9 |
| | 1000 | 7 | 2.4 | 5 | ppm | 12 | ppb | 99.8 |

Column size: 20 cm diameter and 60 cm length

In all the above experiments, strontium, zirconium, uranium and lead were measured by the ICP method; cesium was measured by the radiological method.

Azolla biomass provides an inexpensive means of high purification of waste or contaminated waters as a stand alone method or in complement of other purification techniques which cannot reach such ultrapurification levels.

Azolla biomass can also be used as part of a reclamation process of potable water. Radioactive isotopes are usually present in radioactive waste water at very low metal ion concentrations, below the environmental standards regulation. However, in the nuclear industry, the sources of radioactive isotopes are mostly fission products having a high specific radioactivity and are considered to be hazardous to the environment. These radioactive isotopes have to be removed from the waste solutions to a radioactivity level below, or at the most equal to, the natural radioactivity level, before discharge into the environment. Azolla biomass can be used for clean up of radioactive liquid wastes of very low metal ions concentration, but of high radioactivity level. After metal take up, Azolla biomass can be incinerated reducing considerably the waste volume for further disposal.

A second aspect of the invention is a sampler which enables the determination of very low concentrations of heavy metal ions in water, for which conventional analytical methods are not sensitive enough. The sampler is based on the property of Azolla to bind and concentrate heavy metal ions such as Cu, Zn, Ni, Cr, Pb, Cd, U, Cs, Ce, Ru, Sr, Zr, Ag and Au by up to three order of magnitude from water which flows through the sampler.

The Azolla uptake of metal ions results in an enrichment of the metal ions in the biomass by several orders of magnitude (concentration factor above 1000), over a broad range of pH values, from pH=2 up to pH=11. The Azolla can bind the ions even at very low concentrations, i.e. <1 ppm. This enables the analysis of water composition and content for metal ions using conventional analytical methods which were not sensitive enough to allow the metal ion determination directly from water samples, due to their low concentration. Thus, metal ion concentration in an Azolla biomass sampler avoids lengthy and sensitive preconcentration methods which deal with large volume of solutions.

The Azolla sampler is calibrated by flowing standard solutions through the sampler to determine the specific factor concentration of each metal ion to be sampled. A known volume of solution to be analyzed is flowed through the Azolla sampler. After completion of the sampling, the Azolla bound metals ions are released by acid elution, by acid digestion, or by incineration of the biomass. The biomass incineration is followed by acid digestion of the resulting ashes for qualitative and quantitative analysis by conventional analytical methods. The metal ion concentrations in the solution are calculated using the calibration results.

A further advantage of using Azolla for concentrating ions is its specificity for heavy metal ions. Other sampling methods bind many types of ions and contaminants leading to early saturation of the resin and interference with the binding of the ion whose concentration is to be determined. Azolla, on the other hand, binds heavy metal ions almost exclusively even in the presence of high concentrations of other ions.

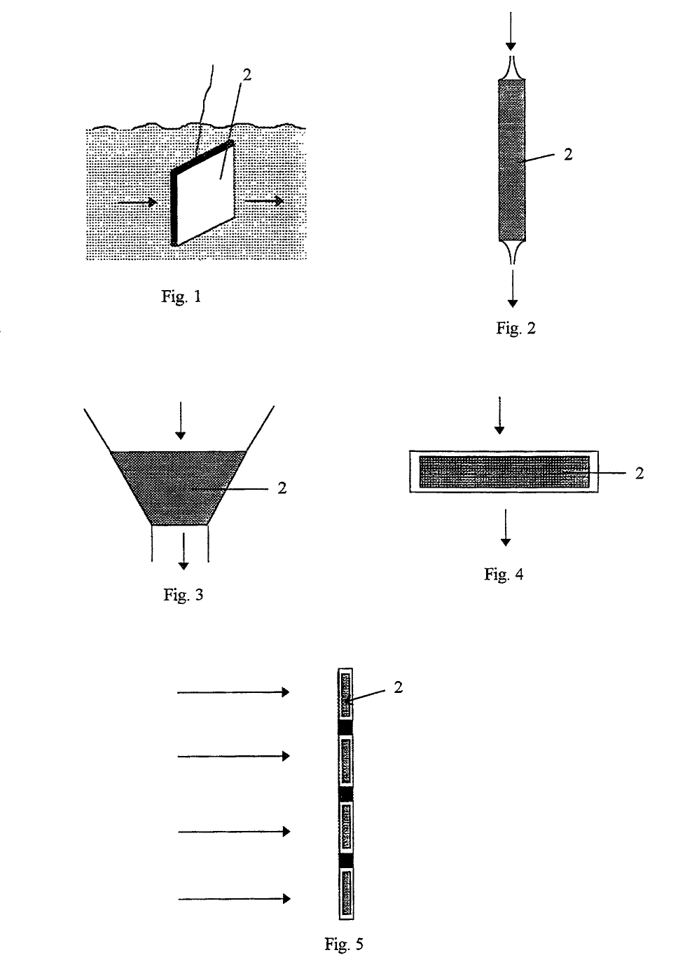

The sampler comprises dry or rehydrated Azolla biomass which is inserted into receptacles of various forms: columns, small bags, funnel form filters and flat filters. Representative samplers are illustrated in FIGS. 1-5, in which the Azolla biomass is denoted by the numeral 2 and of the water stream is indicated by the arrows.

The above samplers can be utilized in laboratories and in situ for sampling of natural standing waters, natural streaming waters, or forced streaming waters using means like pumps. The sampler can be used both qualitatively, to determine the presence of an ion, as well as quantitatively, to determine the concentration of an ion in a body of water by calculation of the volume of water passing through the sampler. A chain of samplers can be prepared to analyze metal ion concentration in natural water at different depths.

Once the metal ions are bound to Azolla biomass in the sampler and the sampling is completed, the metals ions are released from the sampler by acid elution or acid digestion for subsequent analysis by conventional analytical methods. For water or solutions containing γ-emitting radioactive metal ions, the elution or digestion process may be omitted and the sampler is analyzed using conventional nuclear spectroscopic analytical methods. An example follows:

TABLE V
Concentration on Azolla biomass of some
heavy metals of very low contents
in water

| | | | Bio- | | | | | |
|---|---|---|---|---|---|---|---|---|
| Heavy | Volume | | mass | Initial | | Conc. in | | |
| Metal | of Sol. | | amount | solution | | Azolla | | Conc. |
| Ion | (ml.) | pH | (grams) | conc. | | biomass | | factor |
| Strontium | 1200 | 7 | 2 | 1 | ppm | 595 | ppm | 595 |
| Zirconium | 700 | 4.3 | 2 | 1 | ppm | 173 | ppm | 173 |
| Uranium | 600 | 4.5 | 2 | 5 | ppm | 1480 | ppm | 296 |
| Lead | 1000 | 7 | 2 | 1 | ppm | 500 | ppm | 500 |
| Cesium | 1250 | 7 | 5 | 1 | ppb | 245 | ppb | 245 |
| | 8500 | 7 | 5 | 100 | ppt | 167 | ppb | 1670 |
| Chromium | 3000 | 7 | 2 | 140 | ppb | 205 | ppm | 1468 |
| | 3000 | 5 | 2 | 345 | ppb | 484 | ppm | 1404 |
| Ruthen- | 1300 | 5.3 | 5 | 100 | ppb | 20 | ppm | 200 |
| ium | 9000 | 6.8 | 5 | 100 | ppt | 115 | ppb | 1150 |

While the present invention has been described in terms of several preferred embodiments, it is expected that various modifications and improvements will occur to those skilled in the art upon consideration of this disclosure.

The scope of the invention is not to be construed as limited by the illustrative embodiments set forth herein, but is to be determined in accordance with the appended claims.

1. A method for the ultrapurification from a heavy metal ion of an aqueous solution containing said heavy metal ion, the initial concentration of said heavy metal ion being <100 ppm, comprising pumping said solution at a constant flow rate through a dried biomass of the water fern Azolla.

2. A method according to claim 1 wherein said biomass is contained in a column.

3. A method according to claim 1 wherein said heavy metal ion is selected from the group consisting of Cu, Zn, Ni, Cr, Pb, Cd, U, Cs, Ce, Ru, Sr, Zr, Ag and Au.

4. A method according to claim 1 wherein said Azolla is selected from the group consisting of the species Azolla filiculoides, Azolla pinnata, Azolla imbricata, Azolla africana, Azolla caroliniana, Azolla mexicana, Azolla nilotica, Azolla microphyla, Azolla rubra and Azolla japonica.

5. A method according to claim 1 wherein the pH of said solution is in the range of 2-11.

6. A method according to claim 1 wherein the initial concentration of said heavy metal ion in said solution is <1 ppm.

7. A method according to claim 1 wherein the concentration of said heavy metal ion in said solution is reduced to <100 ppb.

8. A method according to claim 1 wherein the concentration of said heavy metal ion in said solution is reduced to <1 ppb.

9. A method according to claim 1 wherein the concentration of said heavy metal ion in said solution is reduced to <1 ppt.

10. A method according to claim 1 wherein said dried biomass is selected from the group consisting of dry or rehydrated dried Azolla, dry or rehydrated crumbled dried Azolla, and dry or rehydrated powdered dried Azolla.

11. A process for the reclamation of contaminated water to produce potable water comprising purifying said contaminated water by pumping said contaminated water at a constant flow rate through a dried biomass of the water fern AzoIla.

12. A process for the purification of radioactively contaminated liquid waste comprising pumping said liquid waste at a constant flow rate through a dried biomass of the water fern Azolla.

13. A process according to claim 12 wherein said biomass is incinerated after said waste has been passed through it.

14. A sampler for determining the presence of a heavy metal ion in an aqueous solution comprising a receptacle containing a dried biomass of the water fern Azolla, wherein said biomass binds said metal ion.

15. A sampler according to claim 14 for determining the concentration of a heavy metal ion in an aqueous solution.

16. A sampler according to claim 14 wherein said heavy metal ion is selected from the group consisting of Cu, Zn, Ni, Cr, Pb, Cd, U, Cs, Ce, Ru, Sr, Zr, Ag and Au.

17. A sampler according to claim 14 wherein said Azolla is selected from the group consisting of the species Azolla filiculoides, Azolla pinnata, Azolla imbricata, Azolla africana, Azolla caroliniana, Azolla mexicana, Azolla nilotica, Azolla microphyla, Azolla rubra and Azolla japonica.

18. A sampler according to claim 14 wherein said receptacle is selected from the group consisting of columns, small bags, funnel form filters and flat filters.

19. A sampler according to claim 14 wherein the pH of said solution is in the range of 2-1.

20. A sampler according to claim 14 wherein the initial concentration of said heavy metal ion in said solution is <100 ppm.

21. A sampler according to claim 20 wherein the initial concentration of said heavy metal ion in said solution is <1 ppm.

22. A sampler according to claim 14 wherein said metal ion is subsequently released from said biomass for subsequent analysis by conventional analytical methods.

23. A sampler according to claim 22 wherein said metal ion is released from said biomass by acid elution or by acid digestion.

24. A sampler according to claim 14 wherein said metal ion is radioactive and is determined in situ by radiospectral analysis of said biomass.

25. A chain of samplers according to claim 14 for use in the determination of the presence of a heavy metal ion in a body of water at successive depths.
